(19) United States
(12) Patent Application Publication
(10) Pub. No.: US 2023/0159358 A1
(43) Pub. Date: May 25, 2023

(54) Process of Mitigation and Control of BioFilm

(71) Applicant: Aquatech International, LLC, Canonsburg, PA (US)

(72) Inventor: Ravi Chidambaran, Canonsburg, PA (US)

(21) Appl. No.: 18/056,985

(22) Filed: Nov. 18, 2022

Related U.S. Application Data
(60) Provisional application No. 63/264,530, filed on Nov. 24, 2021.

(51) Int. Cl. C02F 1/467; C02F 1/50

(52) U.S. Cl. CPC C02F 1/467; C02F 1/50; C02F 2303/20; C02F 2101/306

(57) ABSTRACT

A method for mitigating formation of biofilm in a water system using predictive analysis of biofilm growth. An electrical current to the water system is used to deactivate bacteria and mitigate biofilm formation. The method also allows for optional dosing of the water system with biocide. A system is also used for mitigating formation of biofilm in a water system, made of a bacterial deactivator, a biofouling sensor, a biofouling potential analyzer, and a controller to synthesize data from the analyzer and sensor to model and predict biofouling events and operate the bacterial deactivator based upon the modeling and prediction.

### CROSS REFERENCE TO RELATED APPLICATIONS

This application claims priority to U.S. Provisional Application No. 63/264,530 filed on Nov. 24, 2021, the disclosure of which is hereby incorporated by reference in its entirety.

### BACKGROUND OF THE INVENTION

The present invention relates to a biofilm mitigation and control technology. The present invention relates to a method for mitigation of biofilm formation. The biofilm formation may be in a water containing system. The present invention also relates to a system for mitigating and controlling biofouling in a water system.

A biofilm is a layer of microorganisms contained in a matrix (slime layer), which forms on surfaces in contact with water. Surfaces may be living or non-living surfaces. The presence of biofilms in water pipe networks can be responsible for a wide range of water quality and operational problems. Formation of biofilms occur when free-floating microorganisms attach to a surface. If these microorganisms are not immediately separated from a surface, they can anchor themselves more permanently and allow further microorganisms to attach. An established biofilm structure may comprise microbial cells and an extracellular polymeric substance matrix, and has a defined architecture. Biofilms have importance for public health due to their role in certain infectious diseases.

Biofilm can lead to biofouling, which is the fouling of pipes and underwater surfaces by accumulation of microorganisms, plants, algae, or small animals. This causes degradation to the primary purpose of the surface or item. Biofouling can be influenced by temperature, location, or other pollutants in water.

Biofilm formulation in water containing systems can present a number of issues. Biofilm is a poor thermal conductor, which can affect water containing systems with condensers. This thereby increases power consumption and, thus, the cost of operation.

Initial formation of biofilm can further trigger secondary layers of scaling in water systems, which may include: hardness, heavy metal precipitation, or silica precipitation, all which may exacerbate issues of heat transfer and costly cleaning in said system.

Conventional methods used to control biofouling in a water system include manual mechanical remove, such as scrubbing, or chemical treatments. A set of oxidizing and non-oxidizing biocides are traditionally used, where two oxidizing biocide chemicals and two non-oxidizing biocides chemicals are injected every ten days, alternatively. The chemicals are continuously used in water systems, as there is currently no measurement for the extent of biofouling that may be taking place. In addition, these chemicals can be toxic to environments, and have been banned as a result.

Even with use of conventional methods, the system requires frequent intervention by technicians to maintain the desired plant performance. Additionally, microbes tend to adapt to the chemical environment and continue to survive and grow.

Therefore, there exists a need to control biofilm formation and thus biofouling in water systems which does not require chemical intervention, or only requires little chemical intervention.

### SUMMARY OF THE INVENTION

The present invention relates to a biofilm mitigation and control technology, which is an innovative method to control biological fouling in cooling towers, membrane systems, and other cooling circuits like chilled water systems and beverage handling systems where surface water is pumped in and out of a system, and biofilm formation is experienced.

More specifically, the invention may be a combination of electrical deactivation of bacteria and real time sensing of biofilm potential measurement in the water, which eliminates adverse effects of biological fouling in water systems without using any chemicals.

The invention may control biofouling by integrating continuous electrical deactivation of bacteria, real-time sensing and monitoring of biofilm formation, biocide dosing to be used infrequently only when required, and may include advanced controls, wherein the pattern of biofilm growth can be predictively analyzed to understand the nature of the biofilm and subsequently take preventive action.

### BRIEF DESCRIPTION OF THE DRAWINGS

FIG. 1 is a graph depicting the angle of rate of change for biofouling potential;

FIG. 2 is a graph depicting potential analysis over time for cooling towers;

FIG. 3 is a graph summarizing biofilm potential over time;

FIG. 4 is a graph showing long-term biofilm potential in a cooling tower;

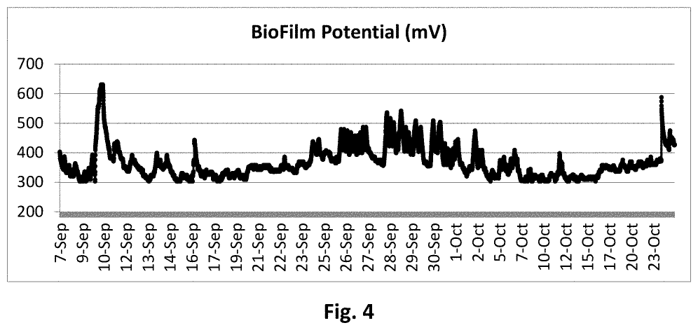

FIG. 5 is a graph showing reverse osmosis operation and feed flow in brackish water;

FIG. 6 is a graph showing operation hours in a system in brackish water;

FIG. 7 is a graph showing ultrafiltration differential pressure on reverse osmosis membranes with seawater; and,

FIG. 8 is an additional graph showing long-term ultrafiltration differential pressure on reverse osmosis membranes with seawater.

### DESCRIPTION OF THE INVENTION

The invention involves technology to eliminate biofouling and its adverse effects, such as biological fouling in water systems. The technology serves to eliminate biofouling without use of any chemicals. Alternatively, the technology eliminates biofouling with only occasional, or minimal, use of small doses of chemicals.

The water systems of the invention may include a cooling tower, evaporator, chiller, liquid waste disposal system, reverse osmosis filtration system, nanofiltration system, a surface water based membrane system, or the like.

In one embodiment of the invention, biofouling is controlled by integrating continuous electrical deactivation of bacteria, real-time sensing and monitoring of biofilm formation, biocide dosing to be used infrequently only when required, and may include advanced controls, wherein the pattern of biofilm growth can be predictively analyzed to understand the nature of the biofilm and subsequently take preventive action.

In another embodiment of the invention, the method of mitigating biofilm in a water system consists of predictively analyzing growth of biofilm in the water system. This may be done to predict formation of a predetermined amount of biofilm.

The biofilm formation may be predictively analyzed with a biofouling potential analyzer. The biofouling analyzer may consist of an electrochemical device. The biofouling analyzer can detect as little as 1% biofilm surface coverage. Most surface waters exhibit a baseline bio-film potential which may be considered “normal” or acceptable. The biofouling analyzer may detect any sudden or step increase in biofilm potential, which indicates the start of biological fouling in the system. The biofouling analyzer can therefore identify early biofilm formation. The biofouling analyzer additionally controls the dosing of supplemental biocide feed. This can be done using real time electrochemical sensing and data monitoring to eliminate biofilm. Use of the biofouling analyzer with additional controls achieves higher operational efficiency with the minimal use of biocides.

In another embodiment of the invention, an electrical current is applied to the water system, called bacteria deactivation. Bacteria deactivation is an electrochemical process.

The weak electric current serves to deactivate biofilm formation. The bacteria deactivation may not necessarily kill bacteria in the water, but may cause it to lose the ability to reproduce and form additional colonies in the water system. The residual mass of the bacteria may flow in and out of the system without forming a biofilm, and without increasing their population. The electric current may be up to 50 mA, or in the range of 15-2 mA in water.

The electrical current deactivates bacteria to mitigate biofilm formation, prior to formation of the predetermined amount of biofilm based upon the predictive analysis. In another embodiment of the invention, the water system may be dosed with biocide.

In another embodiment of the invention, the deactivation of bacteria reduces or eliminates the reproductive capacity of the bacteria.

In another embodiment of the invention, the predictive analysis includes determining biofouling potential by a biofouling analyzer to limit a biofilm coverage level. The biofilm coverage level may be as low as 5%.

In one embodiment of the invention, the biofouling analyzer detects a voltage in the range of 300 to 1200 mV.

In another embodiment of the invention, the voltage of the biofouling analyzer may be converted to an amperage in the range of 4 to 20 mA.

In one embodiment of the invention, biofilm potential sensing can be used to inject biocide in a controlled manner, should the bacteria deactivation get overwhelmed during nonideal feed water conditions. Nonideal feedwater conditions may be due to events such as ingress of a new bacteria culture, or a sudden load of contamination, or the like.

In one embodiment of the invention, a library of past biofouling events may be compiled to enhance prediction of future biofouling events.

In another embodiment of the invention, past biofouling events from a plurality of water systems may be compiled to further enhance prediction of future biofouling events.

In one embodiment of the invention, the prediction for mitigating formation of biofilm in the water system may trigger an alarm when the biofouling event is predicted.

In one embodiment of the invention, the prediction of the biofouling event is carried out by a control system. The control system continuously works to compute the severity of potential biofilm and its nature. The control system prepares a measured response to mitigate the potential problem in advance. Different sources of water along with different species and concentration of bacteria create patterns which may be learned by the control system. The patterns can be correlated with bio-fouling potential by analyzing rate of growth and sustainability of the bacteria. For example, patterns of biofilm signals transmitted to the control system may indicate when the bacteria is trying to form biofilm, however the film is not substantiating, or gaining strength. This may be due to the biofilm being continually dislodged from continuous impact of electrochemical deactivation.

The control system may also compute biofilm signals which indicate that the bacteria is able to sustain growth. Growth rates are observed when readings increase beyond the threshold value of 1000 to 1200 mV. These threshold values may increase or decrease depending upon water source. Surpassing threshold values indicate that the bacteria have gained strength, or are more resistant to electrochemical deactivation, due to being a stronger species or having higher availability of potent food sources. These bacteria may then begin to form a more resistant biofilm, as displayed by sustained and accelerated rate of increase in signals to the biofouling analyzer compared to regular biofilm, which can be controlled and dislodged.

In some embodiments of the invention, the control system may differentiate the above patterns of resistant biofilm versus regular biofilm, and can diagnose such events early. Early diagnosis of biofilm events allows the system to take moderate to aggressive corrective actions early and avoid potential for an aggressive, prolonged action involving biocidal treatment which can be expensive and time consuming. The control system may learn and review instantaneous changes, rate of change over time, or a combination of the same within and above threshold values which may indicate stronger biofilm formation.

The invention may also perform digital biofouling control. The sustainable data-driven solution effectively monitors and controls biofilm formation to restore and maintain operational efficiency with minimal use of chemicals.

The digital optimizer is an IoT feature that remotely monitors and analyzes the sensor data to provide predictive capabilities for intelligently controlling biocide dosing, if required.

The system may continuously measure the rate of increase of biofouling analyzer data over a period of fixed time intervals. In a majority of the cases (greater than 85-90%), the rate of increase in data is such that even a gradual increase within a threshold value will start to decrease due to bacteria deactivator action, eventually leading to normal values indicating zero to minimum biofouling tendency.

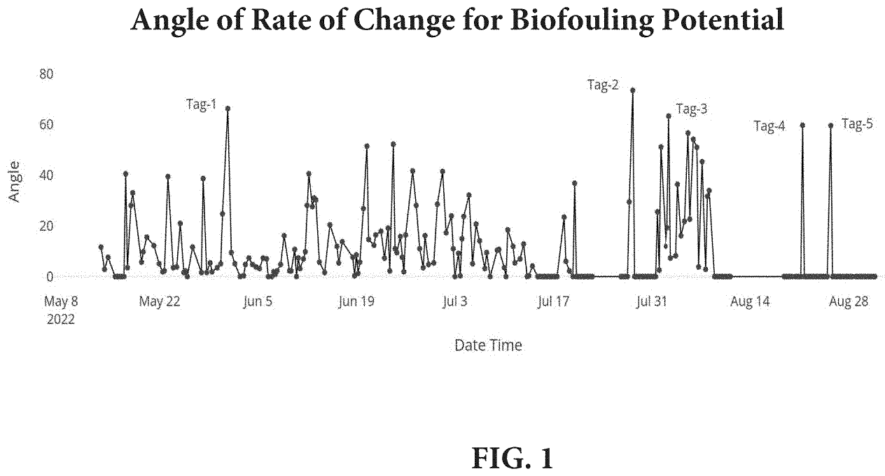

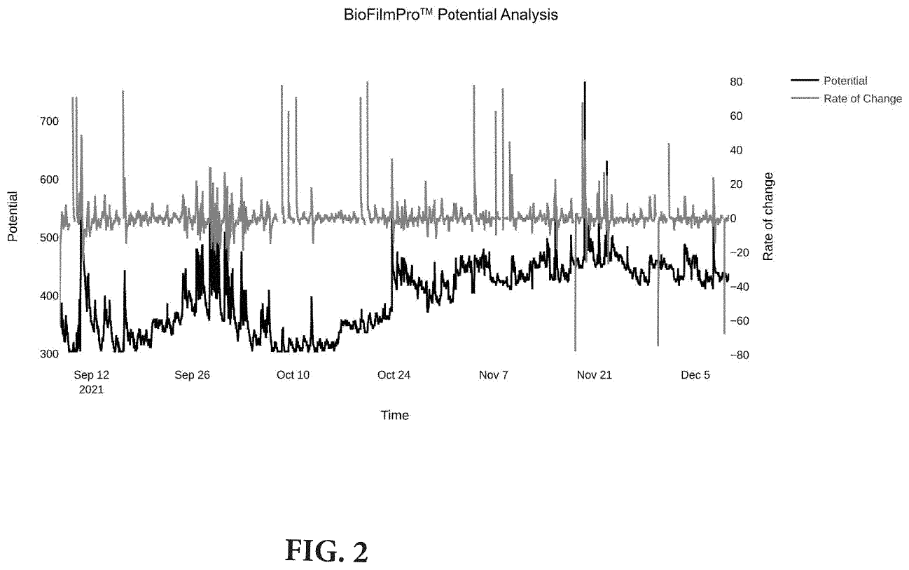

FIGS. 1 and 2 indicate a gradual data increase which may be reduced due to bacteria deactivator action. FIG. 1 shows the rate of change of biofilm potential in degrees. FIG. 2 shows the rate of change of angle in degrees against a biofilm potential reading in millivolts, with the threshold value at 700 mV. The threshold value of 700 mV indicates potential events for biofouling. The figures show that, when the rate of increase of angle increases beyond 60 degrees, the biofilm potential raises above the threshold value and an event of fouling can be predicted. Different water types can raise or lower the threshold level; however, the rate of increase is more likely to be above 45 degrees.

When the rate of growth is above a limit and continuously remains there on a sustained basis, or even increases further, it indicates a stronger biofouling tendency and, if identified in early stages, mild doses of biocides can be released to bring the unit back to normal levels. If allowed to continue, a strong biocide treatment would be required without corrective action, resulting in expensive chemical cleaning as well as down time. The digital optimizer associated with the biofilm will identify such events before any severe biofouling can be created. Data may also be collected over a period of 6-12 months as such events are tagged (see FIG. 1) and the digital optimizer will compare current events with historical events to raise an alarm about a possible recurrence. This will trigger a proactive corrective action, completing the predictive feature of the invention.

Another embodiment of the invention may consist of a system for mitigating and controlling biofouling in a water system. The system may comprise a bacterial deactivator, a biofouling sensor, a biofouling potential analyzer, and a controller. The controller may synthesize data from the analyzer and sensor to model and predict potential biofouling events. Further, the controller may operate the bacterial deactivator based on modeling and prediction, thereby minimizing biofouling in the water system.

In one embodiment of the invention, the bacterial deactivator may be an electrical field.

In another embodiment of the invention, the controller synthesizes additional dta from a plurality of remote biofouling potential analyzers. The plurality of biofouling potential analyzers may be at other water systems.

The water system may be a cooling tower, evaporator, chiller, liquid waste disposal system, reverse osmosis filtration system, nanofiltration system, surface water-based membrane system, or the like.

In yet another embodiment of the invention, the potential biofouling events in the water system may be biofilm formation.

### EXAMPLE 1— Biofilm Mitigation Application on Cooling Tower

Example 1 displays a cooling tower application to compare the performance of chilling condensers using the biofilm analysis and mitigation process versus conventional biocide injection.

In the example, the bacteria deactivator and biofilm sensing system were installed in a 3″ metallic pipe which returned from a chiller condenser to a common cooling tower. The common cooling tower supports a total of 8 chillers. Due to plant specific production conditions, typically 4 to 5 chillers run on a continuous basis. A biofilm monitoring sensor was installed 10 feet downstream from the bacteria deactivator. Sensor output was connected to a control box for controlling the chemical dosing pumps. The signal from the biofilm sensor was remotely monitored over an internet connection from a standard device. The chillers' performance was monitored during a trial period lasting over two months.

The test protocol was developed to observe and compare performance of the deactivator and sensor in comparison to the conventional use of biocides in the system. The measurement of the biofilm sensor signal in mV indicates the strength of the biofilm formation. The mV reading increasing and reducing indicate the bacteria deactivator to dislodge biofilm in early stages of formation. If the mV reading increases beyond a particular threshold, chemical dosing may be enacted.

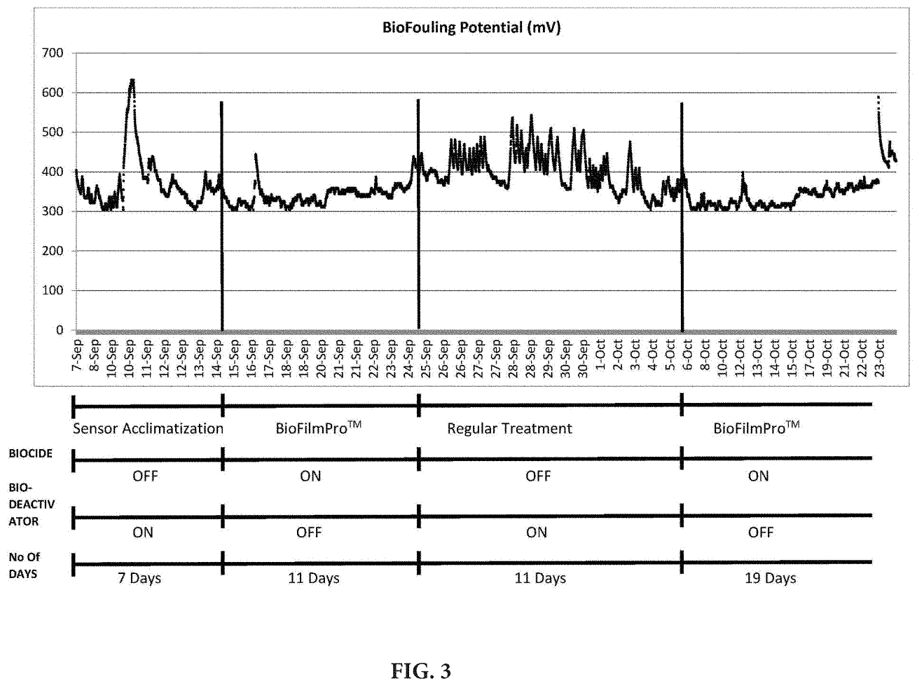

FIG. 3 summarizes the measurement of the biofilm potential signal through the observation period. The observation period included sensor acclimatization and regular treatment.

Sensor Acclimatization while biocide chemical dosing was on: This first 7 day period was used to allow the sensor to start building biofilm on its sensing surface. Biocide injection continued per the existing normal practice and normal behavior of the sensor. Most of the signal averages around 350 mV during this period indicating good biofouling control using biocide chemicals.

Bacteria Deactivation performance-1: After the acclimatization period, for the next 11 days biocide injection was completely stopped and only Bacteria Deactivator was powered used for biofouling control. As can be seen from the signal trend in FIG. 3, biofilm signal was still maintained around 350 mV indicating similar or better level of control using our biofilm analysis and mitigation process.

Conventional Biocide Treatment: For the next 11 days, the biofilm signal was again measured with use of biocide chemicals and without use of the bacteria deactivator. As is evident from results in FIG. 3, the signal reading remained significantly above 350 mV exhibiting worse performance than the prior 11 days period and higher strength of biofilm.

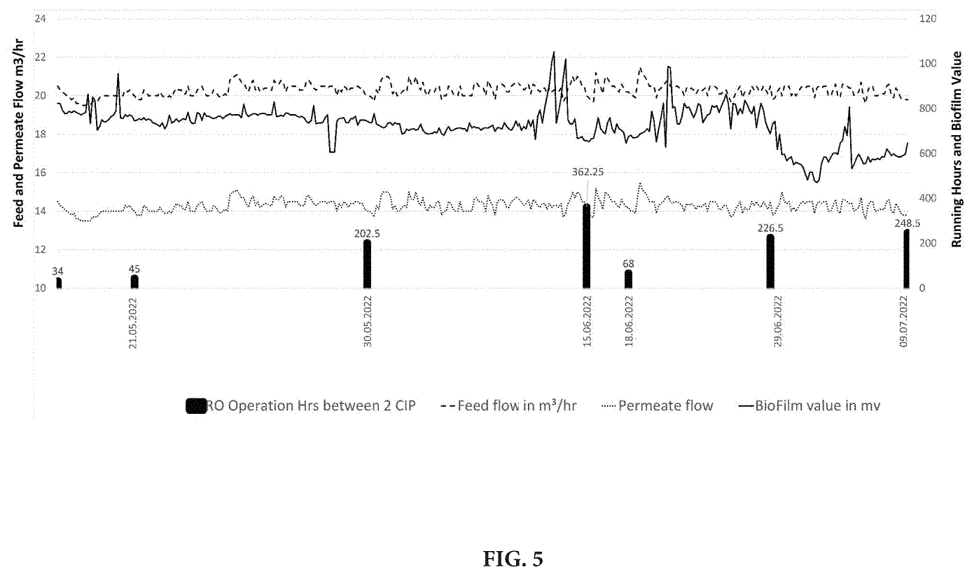

Electrical Bacteria Deactivation-2: The bacteria deactivator was powered again and chemical dosing was completely stopped in this phase. In the initial period the sensor signal is below the 350 mV baseline but later a sudden spike in the signal was observed. Said spike was due to water flow being stopped due to maintenance needs, leading to the system being stagnant for a period of time that allowed bio-film to build on the sensor. FIG. 5 shows the later mV signal as shown below continuing to trend down indicating effect of bacteria deactivation in controlling bio-film formation.

The studies confirmed that the plant performance using the bacteria deactivator and biofouling analyzer remained comparable, or in some cases preferential, to performance with chemical treatment. This will also improve chiller efficiency. Visual observations of the cooling tower indicated reduction in algal growth in the system.

### EXAMPLE 2— Biofilm Mitigation Application on a Brackish Water Reverse Osmosis

The wastewater Reverse Osmosis (RO) plant experienced frequent biofouling problem due to severe microbial growth. Biofilm formation caused increase in differential pressure and reduced permeate flow. Frequent clean in place (CIP) of the RO was necessary to keep the system operational which caused excessive chemical usage, reduced membrane life and involved continuous engagement of manpower leading to higher-than-expected operation cost.

Conventional injection of an oxidizing biocide (Sodium hypochlorite) was used to maintain free chlorine level between 0.3-0.5 ppm. Despite maintaining this residual chlorine level, the system experienced increasing differential pressure levels, which lead to a RO cleaning frequency of on average every 36 hours.

Biofilm analyzer was installed on a 3″ metallic pipe between the UF and the MCF. The signal from biofilm sensor was also remotely monitored over internet connection from standard devices. The sensor was under acclimatization for ten days to collect baseline data. After this the actual test data were collected and following trial phases were conducted to evaluate the performance.

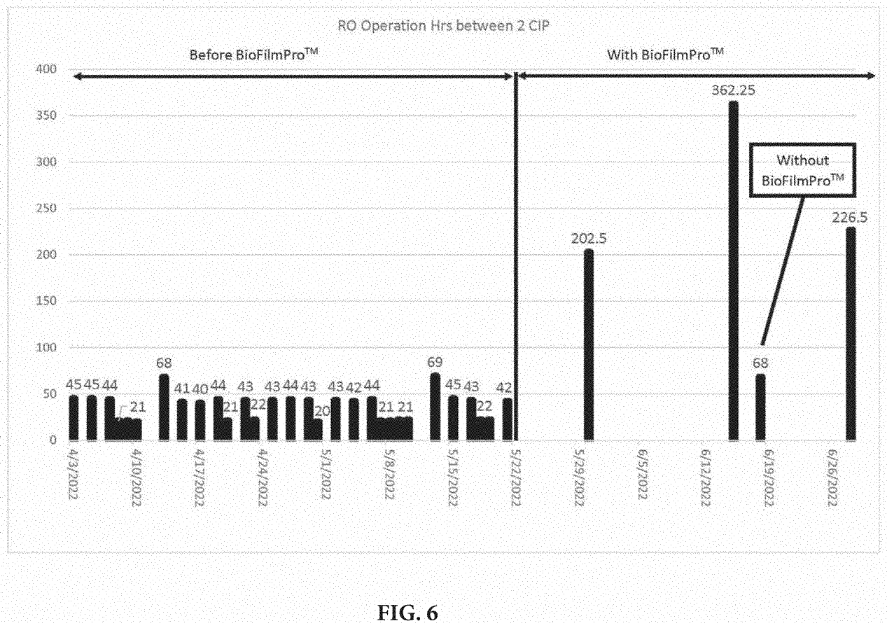

Results: CIP frequency of the RO was observed to reduce from every 2-3 days to every 9-11 days. FIG. 5 displays Reverse Osmosis operation between successive cleanings. Cleaning frequency and plant parameters, such as feed flow, permeate flow, and number of hours of operation between successive cleanings along with the biofilm potential analyzer values are shown in FIG. 5 as well as FIG. 6.

Data displayed in these figures conclude that biological fouling decreases plant efficiency, requiring CIP every 36 hours on average which increases the total cost of operations. The invention lowered CIP to once every 260 hours, indicating the advantages as follows:
reducing plant down time
saving water by reducing CIP frequency by 7-8x
maintain plant efficiency and power saving
reduce chemical cost to 20% of previous levels
Eliminate human interventions by real time monitoring with data logging and alarm capability

### EXAMPLE 3— Biofilm Mitigation Application on a Sea Water Reverse Osmosis

A Biofilm system was installed in a Salt Water Reverse Osmosis (SWRO) system. The system consisted of pretreatment of clarifier, followed by Media filters and ultrafiltration membranes (UF) permeate storage tank. The pretreated sea water is then passed through a cartridge filter to Sea water system at around 58-60 bar pressure.

The sea water system used to experience frequent biofouling which required chemical cleaning every month as the differential across membranes will go up by 1.5-2.0 kg/cm2. To mitigate and control biofouling, a biofilm system was installed including a Bacteria deactivator and Biofilm potential sensor were installed.

In the case of sea water, due to higher total dissolved salts of 42-45000 ppm and consequently high conductivity the base sensor output in milli volts is higher around 850-900 my more than what is experienced in brackish water.

The initial readings in the sensor were higher than expected. This may be due to accumulation of biofilm in the system like equipment and piping. After the installation of the Biofilm system upstream of ultrafiltration system and allowing some pre-conditioning time the sensor output started showing decline in the output values and then stabilized.

The differential pressure UF immediately reduced to 0.2-0.3 kg/cm2 from 0.5-0.5-1.01.0 kg/cm2. This is due to reduced biofouling on membranes. This also reduced the need for daily chemical enhanced back washing and the UF membrane chemical cleaning also reduced to once in a year from once a month.

The trend of differential pressure in RO moving up and down somewhat resembled the trend of my readings sensor especially the increasing trend. This indicated that differential pressure increasing with increasing biofilm potential as read by the sensor. It was observed that the differential pressure values almost stabilized in a narrow range of 1.5-1.75 kg/cm2 after installation of bio film pro. The increase in differential pressure across sea water RO membranes reduced significantly to an extent that membrane chemical cleaning reduced to once in 3-6 months.

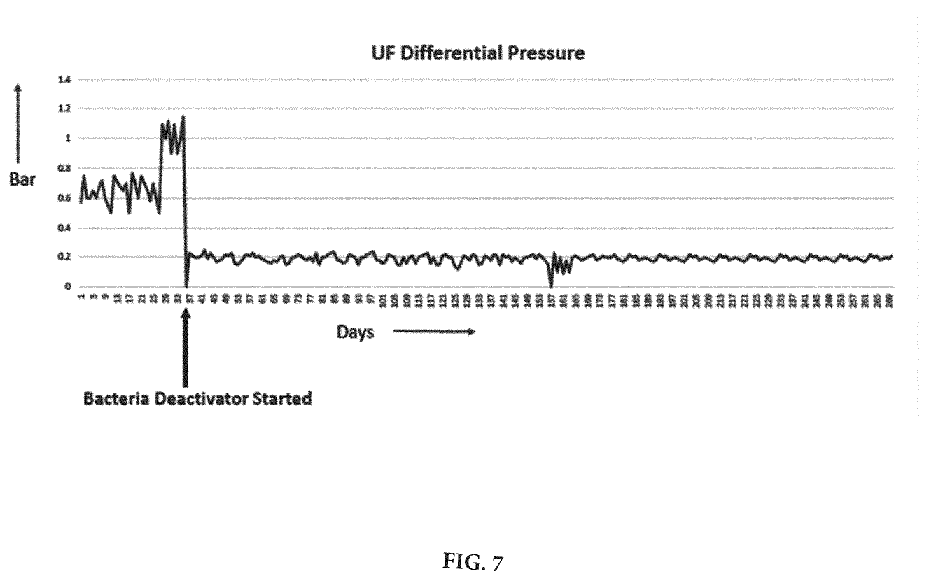

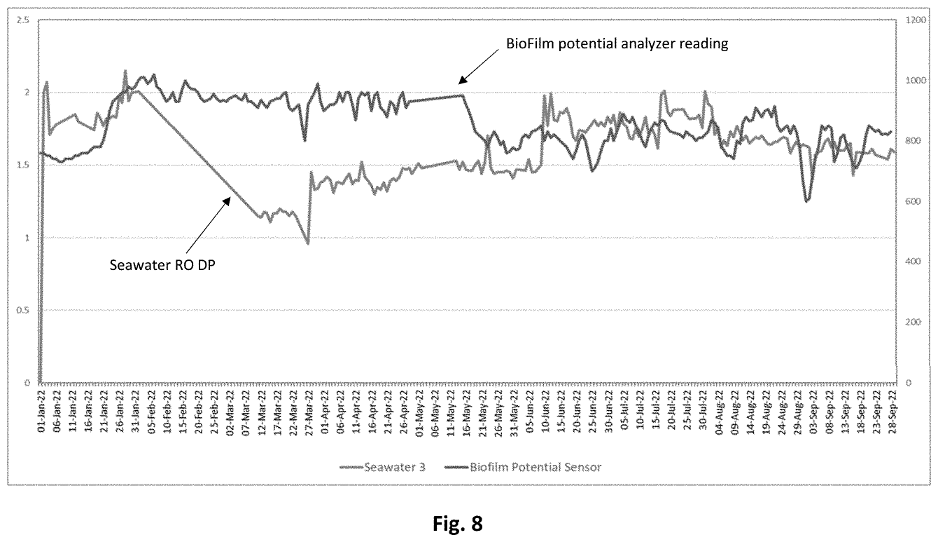

The data on UF differential pressure before and after and the data on RO membranes before and after installation of Bio film Pro are shown in attached FIGS. 7 and 8.

I claim:

1. A method for mitigating formation of biofilm in a water system, comprising:
predictively analyzing growth of biofilm in a water system to predict formation of a predetermined amount of biofilm;
applying an electrical current to the water system, thereby deactivating bacteria and mitigating biofilm formation, prior to formation of the predetermined amount of biofilm based on the predictive analysis; and
optionally, dosing the water system with biocide.

2. The method of claim 1, wherein deactivation of bacteria reduces or eliminates reproductive capacity of the bacteria.

3. The method of claim 1, wherein the predictive analysis includes determining biofouling potential by a biofouling analyzer to limit biofilm coverage level as low as 5%.

4. The method of claim 3, wherein the biofouling analyzer detects a voltage between 300 mV to 1200 mV.

5. The method of claim 4, wherein the voltage is converted to an amperage between 4 mA to 20 mA.

6. The method of claim 1, further comprising compiling a library of past biofouling events to enhance prediction of future biofouling events.

7. The method of claim 6, further comprising aggregating past biofouling events from a plurality of water systems to further enhance prediction of future biofouling events.

8. The method of claim 1, further comprising triggering an alarm when a biofouling event is predicted.

9. The method of claim 1, wherein the water system is selected from the group consisting of a cooling tower, evaporator, chiller, liquid waste disposal system, reverse osmosis filtration system, nanofiltration system, and surface water-based membrane system.

10. A system for mitigating and controlling biofouling in a water system, comprising:
a bacterial deactivator;
a biofouling sensor;
a biofouling potential analyzer; and
a controller, wherein the controller synthesizes data from the analyzer and sensor to model and predict potential biofouling events, and wherein the controller operates the bacterial deactivator based on the modeling and prediction, thereby minimizing biofouling in the water system.

11. The system of claim 10, wherein the bacterial deactivator is an electric field.

12. The system of claim 10, wherein the controller synthesizes additional data from a plurality of remote biofouling potential analyzers at other water systems.

13. The system of claim 10, wherein the water system is selected from the group consisting of a cooling tower, evaporator, chiller, liquid waste disposal system, reverse osmosis filtration system, nanofiltration system, and surface water-based membrane system.

14. The system of claim 10, wherein the potential biofouling events comprise biofilm formation.
